(19) United States
(12) Patent Application Publication
(10) Pub. No.: US 2022/0395786 A1
(43) Pub. Date: Dec. 15, 2022

(54) THICKENING CARBON DIOXIDE DISPLACEMENT VISUAL ANALOG DEVICE

(71) Applicant: Yangtze University, Jingzhou (CN)

(72) Inventors: Meilong Fu, Jingzhou (CN); Baofeng Hou, Jingzhou (CN); Jiani Hu, Jingzhou (CN)

(21) Appl. No.: 17/664,403

(22) Filed: May 20, 2022

(30) Foreign Application Priority Data
Jun. 11, 2021 (CN) 202110658136.1

(51) Int. Cl. B01F 23/00; B01F 35/21; B01F 35/221; B01F 33/80

(52) U.S. Cl. CPC B01F 23/043; B01F 35/2113; B01F 35/2215; B01F 35/2115; B01F 33/80; E21B 43/164

(57) ABSTRACT

The invention discloses a kind of thickening carbon dioxide displacement visual analog device, including pressure boost module, visual stirring vessel module and displacement analog module; the mentioned pressure boost module, visual stirring vessel module and displacement analog module are connected successively; the invention is used to develop the experimental study including evaluation of gas injection miscible-phase/non-miscible-phase displacement efficiency, percolation characteristics during gas displacement, mobility control technology during gas drive, and optimization of gas injection way.

### CROSS-REFERENCE TO RELATED APPLICATIONS

This application claims the benefit and priority of Chinese Patent Application Number 202110658136.1, filed on Jun. 11, 2021 with China National Intellectual Property Administration, the disclosures of which are incorporated herein by reference in their entireties.

### TECHNICAL FIELD

This invention involves the field of petroleum engineering and process technology, more specifically, it involves a kind of thickening carbon dioxide displacement visual analog device.

### BACKGROUND TECHNOLOGY

At present, the carbon dioxide displacement technology is a technology that carbon dioxide is injected into the oil reservoir to improve the tar productivity of oil field. The carbon dioxide cannot form a mixed phase in its first contact with formation oil, but it can form the leading edge of mixed phase under appropriate pressure, temperature, and crude oil components. Supercritical fluid will extract relatively heavy hydrocarbon from crude oil and continuously concentrate the gas in the leading displacement edge. Carbon dioxide and crude oil will become the mixed-phase liquid to form single liquid phase, then, formation oil can be effectively displaced to the producing well. Pure liquid CO₂ has extremely low viscosity, only 0.1 mPa·s, while oil phase has a viscosity of 2-100 mPa·s and even higher. Liquid CO2 is used as displacing fluid and the mixed phase will reduce the viscosity of crude oil, but its mobility ratio is still too large, which is not conducive to displacement and the main cause of fingering and gas channeling; the supercritical point of carbon dioxide is far lower than the condition of reservoir, where, its critical temperature is 31.26° C. and critical pressure is 7.38 MPa. Under the supercritical state, its density is close to that of liquid, its viscosity is close to that of gas, and its diffusion coefficient is 100 times of that of liquid, which are more adverse for the displacement and very easily causes gas channeling in advance. Can the viscosity of CO₂ be greatly increased, the supercritical point of CO₂ be greatly increased, and the mobility ratio be significantly improved like polymer displacement to improve the displacement efficiency and inhibit the gas channeling.

Therefore, the carbon dioxide displacement analog device for the above problems is a key problem that technicians in this field urgently need to solve.

### Invention Contents

In view of this, the invention provides a kind of thickening carbon dioxide displacement visual analog device and is used to develop the experimental study including evaluation of gas injection miscible-phase/non-miscible-phase displacement efficiency, percolation characteristics during gas displacement, mobility control technology during gas drive, and optimization of gas injection way, which can provide technical support for better improving the development effect of low permeability reservoir and improving the recovery efficiency of low permeability reservoir and provide data preparation for the mathematical model research.

In order to achieve the above purposes, the invention adopts the following technical proposals:

A kind of thickening carbon dioxide displacement visual analog device includes pressure boost module, visual stirring vessel module and displacement analog module;

The mentioned pressure boost module, visual stirring vessel module and displacement analog module are connected successively.

Preferably, the mentioned visual stirring vessel module includes main pump component, visual stirring vessel component, temperature control device, pressure measurement device, first stirrer device, second stirrer device, volume collection device and data processing equipment;

The mentioned main pump module is connected with the mentioned visual stirring vessel component, and the mentioned visual stirring vessel component is connected with the mentioned first stirrer device and the mentioned second stirrer device;

and the mentioned visual stirring vessel component is electrically connected with the mentioned pressure measurement device and the mentioned temperature control device, the mentioned main pump module is electrically connected with the mentioned volume collection device, and the mentioned temperature control device, the mentioned pressure measurement device and the mentioned volume collection device is electrically connected with the mentioned data processing equipment.

Preferably, the mentioned displacement analog module includes thermostat.

Preferably, the thermostat is equipped with a holder, one end of the mentioned holder is connected with the mentioned injection valve, a pressure inlet is set between the mentioned holder and the mentioned injection valve, the other end of the mentioned holder is connected with the mentioned condenser, a pressure inlet is set between the mentioned holder and the mentioned condenser, and the mentioned holder is connected with the mentioned manual pump.

Preferably, the mentioned pressure boost module includes air compressor, booster pump, air storage tank and pressure regulating valve successively connected, which is used to pressurize the low-pressure gas at the steel cylinder into high-pressure gas by using the gas booster pump. The high-pressure gas is stored in the high-pressure gas storage tank, the output pressure of high-pressure gas is adjusted to be stable through the precision pressure regulating valve and then it is injected into the physical model.

It can be known from the above technical proposals that the invention publicly provides a kind of thickening carbon dioxide displacement visual analog device and is used to develop the experimental study including evaluation of gas injection miscible-phase/non-miscible-phase displacement efficiency, percolation characteristics during gas displacement, mobility control technology during gas drive, and optimization of gas injection way, which can provide technical support for better improving the development effect of low permeability reservoir and improving the recovery efficiency of low permeability reservoir and provide data preparation for the mathematical model research.

### INSTRUCTION WITH ATTACHED FIGURES

In order to explain more clearly the examples of the invention or the technical proposal in the existing technology, the following is a brief introduction to the examples or the attached figures to be used in the description of existing technology. Obviously, the attached figures in the following description are only the examples of the invention. The general technicians in this field may obtain other attached figures according to the attached figures provided without creative labor.

FIG. 1 is the structural diagram of a kind of thickening carbon dioxide displacement visual analog device provided by the invention.

FIG. 2 is the structural functional block diagram of visual stirring vessel module provided by the invention.

FIG. 3 is the structure chart of visual stirring vessel module provided by the examples of the invention.

### DETAILED MODE OF EXECUTION

A clear and complete description of the technical proposal for the examples of the invention is given below in combination with the attached figures in the examples of the invention. Obviously, the described examples are only a part of the examples of the invention, not all of the examples. Based on the examples in the invention, all other examples obtained by general technicians in the field without creative labor are within the scope of protection of the invention.

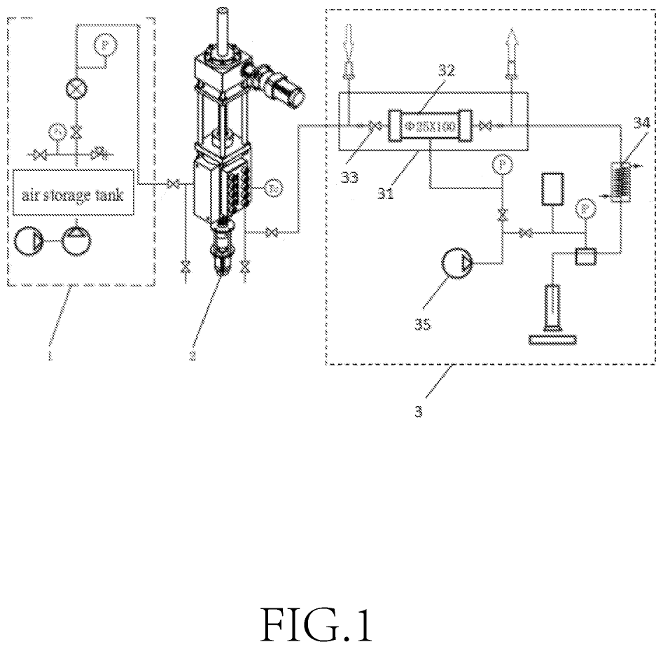

As shown in FIG. 1, the examples of the invention discloses a kind of thickening carbon dioxide displacement visual analog device including pressure boost module 1, visual stirring vessel module 2 and displacement analog module 3;

Pressure boost module 1, visual stirring vessel module 2 and displacement analog module 3 are connected successively.

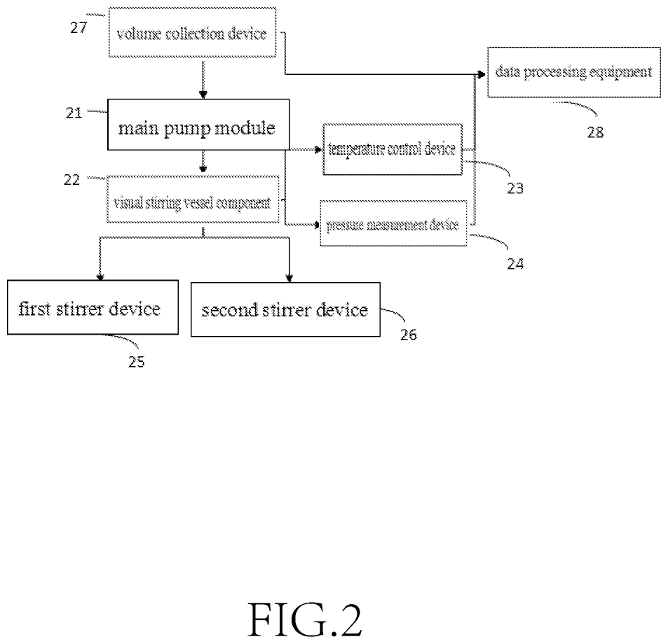

As shown in FIG. 2, in a detailed example, visual stirring vessel module 2 includes main pump component 21, visual stirring vessel component 22, temperature control device 23, pressure measurement device 24, first stirrer device 25, second stirrer device 26, volume collection device 27 and data processing equipment 28;

Main pump module 21 is connected with visual stirring vessel component 22, and visual stirring vessel component 22 is connected with first stirrer device 25 and second stirrer device 26;

Visual stirring vessel component 22 is electrically connected with pressure measurement device 24 and temperature control device 23, main pump component 21 is electrically connected with volume collection device 27, and temperature control device 23, pressure measurement device 24 and volume collection device 27 are electrically connected with data processing equipment 28.

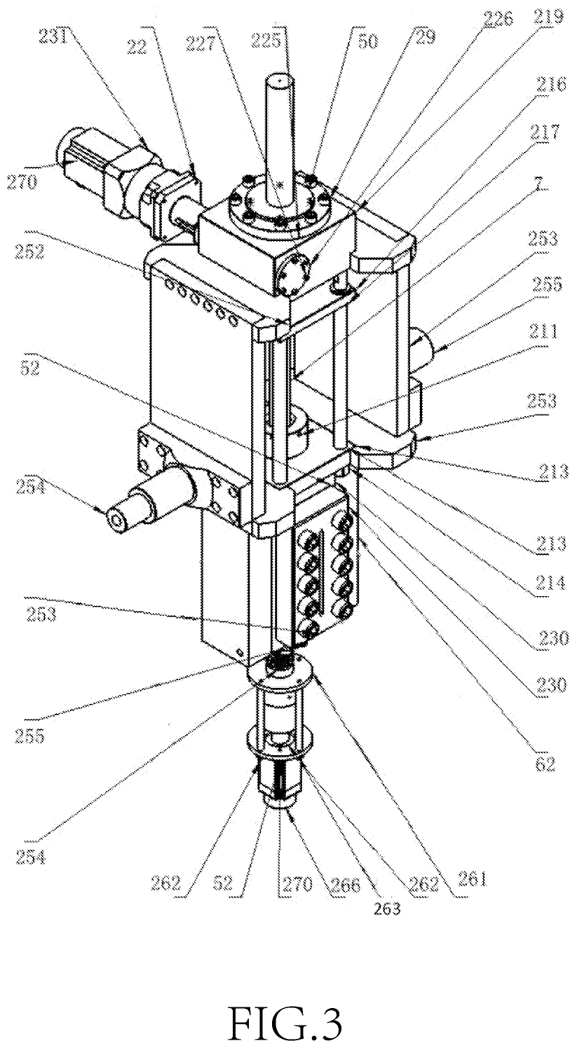

Specifically, as shown in FIG. 3, main pump component 21 includes pressing cap 211, front support 212, pull rod 213, thickened nut 214, ball screw 215, centralizing bracket 216, plunger, slide bushing 217, screw nut 218, rear support 219, small bearing cap 220, small shaft sleeve 221, turbine 222, worm 223, left connecting casing 224, rear bearing cap 225, worm bearing cap 226, reduction gear fixed base 227, coupling 228, screw boot cap 229, motor I 230 and reduction gear 231;

Both ends of worm 223 and bearing are matched with turbine 222 in the rear support, reduction gear 231 and worm 223 are connected with coupling 228 and permanently connected with rear support 219 through reduction gear fixed base 227 with nut bolt, ball screw 215 and plunger are connected through thread after matched with screw nut 218, small shaft sleeve 221 and screw nut 218 are permanently connected through nut bolt, turbine 222 is permanently connected with left connecting casing 224 and small shaft sleeve 221 through nut bolt, left connecting casing 224 and small shaft sleeve 221 are placed in the rear support after bearings are installed on them and limited by small bearing cap and rear bearing cap 225, and small bearing cap and rear bearing cap 225 are connected through nut bolt and fixed on the rear support 219; screw boot cap 229 is connected through nut bolt and fixed with rear bearing cap 225, and pull rod and slide bushing are matched with centralizing bracket after matched; and plunger and centralizing bracket are matched.

Visual stirring vessel component 22 can include visual glass fiber laminate, long-window red-copper sealing gasket, long-window glass, long-window glass sealing washer, pump body and pump body water jacket;

Long-window glass is placed in the pump body and sealed through long-window glass sealing washer, long-window red-copper sealing gasket is placed on the long-window glass, pressed by visual glass and fixed with the pump body through nut bolt connection, and the water jacket is fixed on both sides of the pump body.

Specifically, first stirrer device 25 includes rotating fixed plate 251, rotating fixed plate B252, rotating fixed plate C253, rotating shaft 254, rotating shaft B255, stirring block I 256 and stirring block II 257;

Rotating fixed plate C is connected with rotating fixed plate and rotating fixed plate B through nut bolt, rotating shaft and rotating shaft B are connected with rotating fixed plate C through nut bolt.

Specifically, second stirrer device 26 includes stirring head barrel 261, agitator arm 262, agitator blade 263, support plate under the motor 264, internal magnetic protective casing 265, external magnetic casing 266, small plug 267, deep groove ball bearing, bearing washer, support plate on the motor 268, motor support rod 269 and motor II 270;

and support plate under the motor 264 is connected with stirring head barrel 261 through thread, agitator blade 263 is connected with agitator arm 262 through nut bolt, agitator arm 262 is connected with stirring head barrel 261 after bearing is installed on it, small plug 267 is connected with stirring head barrel 261 through thread and connected with external magnetic casing after bearing is installed on it, the bearing washer is installed between two bearings, support plate on the motor 268 and support plate under the motor 264 are connected and positioned through motor support rod 269, and motor II 270 is connected with support plate on the motor 268 and external magnetic casing 266.

The main pump cylinder of visual stirring vessel component 22 and visual stirring vessel component are combined, which controls the pressure through the pull rod type piston motion of main pump and precisely measures and records the parameters of pressure and volume of samples inside stirring vessel; and it has harm to the operator. The pump adopts pull rod type piston structure, and pump cylinder and upper plug are made of corrosion-resistant materials. There is no plunger piston annular space inside visual stirring vessel component, its dead volume is small, and the hole inside the pump cylinder adopts honing technology with fine processing and accurate size. The pump body drive drives the piston rod through worm gear and drive screw rod. Drive screw rod rolling double screw rod with high precision, flexible drive and convenient operation.

The fluid samples inside visual stirring vessel component are stirred with 180 degree electronic agitator. The chain sprocket drive of motor and reduction gear drives the main pump to swing and stir at 180 degrees, and the swing frequency can be adjusted from 0 to 20 times/min. Meanwhile, the magnetic stirring motor at the top of visual stirring vessel component drives the permanent magnetic rotating impeller at the top of visual stirring vessel component to rotate and stir the fluid samples in the cylinder through electromagnetic induction. The speed of the rotating stirring impeller can be adjusted through the magnetic stirring motor, the rotation speed range is 0-100 rpm, and the two stirring forms are carried out simultaneously. The sample stirring is fully uniform, the stirring efficiency is high, and the samples in the visual stirring vessel component fully reaches the thermal phase equilibrium in a short time, improving the analysis accuracy of the samples.

In a specific example, displacement analog module 3 includes thermostat 31.

In a specific example, thermostat 31 is equipped with holder 32, one end of holder 32 is connected with injection valve 33, a pressure inlet is set between holder 32 and injection valve 33, the other end of holder 32 is connected with condenser 34, a pressure inlet is set between holder 32 and condenser 34, and holder 32 is connected with manual pump 35.

In a specific example, pressure boost module 1 includes air compressor 11, booster pump 12, air storage tank 13 and pressure regulating valve 14 successively connected.

The detailed use processes of the thickening carbon dioxide displacement visual analog device involved in the invention are shown as follows:

(1) CO₂ gas is pressurized in the pressure boost module according to the requirements required by the experiment;

(2) The temperature is controlled in the visual stirring vessel to mix CO₂ and thickening agent, improving the viscosity of CO₂;

(3) The permeability, porosity and saturated formation water of core model are tested;

(4) After the core is heated to formation temperature, the simulated oil is injected into the core of saturated water until the effluent is all oil, and the oil-water saturation in the core is calculated; and

(5) Under the temperature constant state in the thermostat, CO₂ gas after processed in steps (1) and (2) is injected into the core model at a certain pressure, the outlet valve is opened after the injection pressure is kept for 5 min so that oil gas is spit out until the core has no pressure and there is no fluid outflowing, and the volume of oil, water and gas is calculated, respectively.

Each example in the instructions is described in a progressive manner. Each example focuses on the description of the differences from other examples and the same and similar parts among various examples can be referred to each other. For a device for which an example is disclosed, the description is relatively simple because it corresponds to the method for which the example is disclosed, and the relevant parts can refer to the description of method part.

The mentioned description of the example disclosed enables the professional technicians in the field to realize or use the invention. A variety of modifications to these examples will be apparent to the professional technicians in the field, and the general principles defined herein may be achieved in other examples without prejudice to the spirit or scope of the invention. Therefore, the invention will be not limited to those examples listed herein, but should conform to the widest range consistent with the principles and novel characteristics presented herein.

We claim:

1. A kind of thickening carbon dioxide displacement visual analog device is characterized that: it includes pressure boost module (1), visual stirring vessel module (2) and displacement analog module (3);
wherein the mentioned pressure boost module (1), visual stirring vessel module (2) and displacement analog module (3) are connected successively.

2. The kind of thickening carbon dioxide displacement visual analog device mentioned in claim 1 is characterized that: the mentioned visual stirring vessel module (2) includes:
main pump module (21), visual stirring vessel component (22), temperature control device (23), pressure measurement device (24), first stirrer device (25), second stirrer device (26), volume collection device (27) and data processing equipment (28);
wherein the mentioned main pump module (21) is connected with the mentioned visual stirring vessel component (22), and the mentioned visual stirring vessel component (22) is connected with the mentioned first stirrer device (25) and the mentioned second stirrer device (26);
wherein the mentioned visual stirring vessel component (22) is electrically connected with the mentioned pressure measurement device (24) and the mentioned temperature control device (23), the mentioned main pump module (21) is electrically connected with the mentioned volume collection device (27), and the mentioned temperature control device (23), the mentioned pressure measurement device (24) and the mentioned volume collection device (27) is electrically connected with the mentioned data processing equipment (28).

3. The kind of thickening carbon dioxide displacement visual analog device mentioned in claim 1 is characterized that: the mentioned displacement analog module (3) includes thermostat (31).

4. The kind of thickening carbon dioxide displacement visual analog device mentioned in claim 3 is characterized that: the thermostat (31) is equipped with a holder (32), one end of the mentioned holder (32) is connected with the mentioned injection valve (33), a pressure inlet is set between the mentioned holder (32) and the mentioned injection valve (33), the other end of the mentioned holder (32) is connected with the mentioned condenser (34), a pressure inlet is set between the mentioned holder (32) and the mentioned condenser (34), and the mentioned holder (32) is connected with the mentioned manual pump (35).

5. The kind of thickening carbon dioxide displacement visual analog device mentioned in any item according to claim 1 is characterized that: the mentioned pressure boost module (1) include the air compressor (11), booster pump (12), air storage tank (13) and pressure regulating valve (14) successively connected.
